(19) United States
(12) Patent Application Publication
(10) Pub. No.: US 2004/0009312 A1
(43) Pub. Date: Jan. 15, 2004

(54) Waterfast compositions for ink jet recording sheets

(76) Inventor: Michael F. Koenig, Goshen, NY (US)

Correspondence Address: Dara L. Onofrio, Esq., c/o ONOFRIO LAW, Suite 1600, 1133 Broadway, New York, NY, 10010, US

(21) Appl. No.: 10/456,213

(22) Filed: Jun. 6, 2003

Related U.S. Application Data
(60) Provisional application No. 60/387,361, filed on Jun. 10, 2002.

(51) Int. Cl. B41M 5/00

(52) U.S. Cl. 428/32.15; 428/32.29; 428/32.3

(57) ABSTRACT

Waterfast coating compositions which are comprised of a blend of a dye fixative and a dispersion of metal oxide particles to form a water-insoluble complex. The ink recording sheets comprise a composition that is absorbed into the surface of the substrate as a sizing material, or alternatively, forms a continuous layer on the substrate. The present invention also encompasses methods for making the ink jet receiving sheets.

This application claims the benefit of U.S. Provisional Application Serial No. 60/387,361 filed on Jun. 10, 2002, which is incorporated herein by reference.

### FIELD OF INVENTION

The present invention relates to waterfast ink jet recording compositions and sheets. In particular it relates to coating compositions which are comprised of a blend of a dye fixative and a dispersion of metal oxide particles to form a water-insoluble complex. These compositions are coated on at least one surface of a substrate to make an ink recording sheet. The composition is absorbed into the surface of the substrate as a sizing material, or alternatively, forms a continuous layer on the substrate.

### BACKGROUND OF INVENTION

Ink jet coatings that are waterfast or waterproof are highly desirable in the ink jet printing industry. In general, there are two methods in the prior art for making an ink jet coating waterfast or waterproof. The first involves using a water-insoluble binder, such as a latex or a cross-linked polymer (e.g. cross-linked polyvinyl alcohol). By using a water-insoluble binder, the coating will maintain its strength when exposed to water. This concept applies both to coatings that are composed of only a binder (polymer) component and to coatings that are composed of binder plus pigment. This is the approach that is described in U.S. Pat. No. 4,877,680 to Sakaki et al. as well as U.S. Pat. No. 5,270,103 to Oliver et al.

However, since most dye fixatives and most dyes or inks are water soluble, even if the binder is water-insoluble, the dye, which forms a printed image on the paper, will still have a tendency to run or bleed if it makes contact with water. Thus, water-insoluble binders should only be used if the dye fixative/dye complex is also water-insoluble.

The second method involves using a dye fixative of high molecular weight. When the paper is imaged, the dye from the ink jet ink can complex with the dye fixative, thereby decreasing the solubility of the dye and increasing its water resistance. This method can be used if the fixative is water soluble or insoluble. However, for best waster resistance, if the fixative is water soluble, it should also have a sufficient number of absorptive sites so that the resulting dye fixative/dye complex is water insoluble. This approach is described by Sugiyama et al. in U.S. Pat. No. 4,371,580.

Because this method requires using a dye fixative of high molecular weight, and in some case, with a sufficient number of absorptive sites, the selection of available dye fixatives is significantly reduced. The high molecular weight will also make the ink jet coating more viscous, and hence more difficult to pump and coat during the manufacturing process.

A need therefore exists to provide a more cost effective and efficient way to make ink jet recording sheets with excellent waterfast properties.

The present invention is an improvement over the prior art methods for making waterfast ink jet recording sheets. In the present invention, it is now possible to use a greater selection of dye fixatives because the fixative is successfully bound to the substrate using a dispersion of metal oxide as a binder to bind the dye fixative. The present invention comprises a composition containing a blend of a dye fixative and a dispersion of metal oxide particles. The blend forms a water-insoluble complex. The dye or ink will adhere to the water-insoluble complex and will not wash off the surface of the substrate.

The compositions are absorbed into the surface of the substrate as a sizing material, or alternatively, form a continuous layer on the substrate surface. The resulting waterfast ink jet recording sheets made using these compositions are therefore an important improvement over the prior art.

Accordingly it is the broad object of the present invention to provide a composition and an ink jet recording sheet having improved waterfast qualities.

Additionally, it is another object of the present invention to provide a coating composition for use in an ink jet recording sheet having unexpected enhanced print performance, i.e., an increase in print density and print resolution along with reduced wicking and color-to color bleed.

It is another object of the present invention to provide a coating composition and ink jet recording sheet, which can be used with a wider variety of inks.

It is a further object of this invention to provide an ink jet recording sheet that is more cost effective and easier to manufacture than the current ink recording sheets.

It is yet another object of the present invention to provide a method for making an ink jet recording sheet to create these improved ink jet recording sheets and images.

### SUMMARY OF THE INVENTION

The present invention is a coating composition comprising a blend of a dye fixative and a dispersion of metal oxide particles that forms a water-insoluble complex.

The dye fixative is a cationic polymer selected from the group consisting of dicyandiamide-formaldehyde resin, polyethylenimine-epichlorohydrin, polydiallyidimethylammonium chloride (p-DADMAC or p-DMDAAC), polyacrylamide, and cationic polymers which contain primary, secondary, tertiary or quaternary amine functionalities. The cationic polymers containing amine functionalities include cationic starches, cationic polyvinyl alcohols, cationic vinyl polymers, cationic styrene-containing polymers, cationic polyurethanes, quaternary amine salts, and the like. Preferably, the cationic polymer is a quaternary ammonium salt and most preferably, benzyl cocalkyl dimethyl quaternary ammonium chloride.

The metal oxide is selected from the group consisting of colloidal silica, colloidal alumina, colloidal zirconia, and colloidal titanium dioxide. Most preferably, the silica is amorphous.

The ratio of metal oxide dispersion to dye fixative is in the range 1:20 to 1:1, preferably 1:4.

The present invention is also directed to an ink recording sheet comprising a substrate coated on at least one side with a composition comprising the blend of dye fixative and metal oxide dispersion. Preferably, the substrate is selected from the group consisting of paper, textile and plastic film.

In one embodiment, the composition forms a continuous film on the substrate. Preferably the continuous film is used as an ink receiving layer, which may be combined with other materials. In a second embodiment, the composition containing the water-insoluble complex is absorbed into the surface of the substrate as a sizing material.

In the embodiment wherein the composition is an ink receiving layer, the ink receiving layer may further comprise a material selected from the group consisting of binders, pigments, defoamers, surfactants, thickeners and a combination of at least two of the above.

In the embodiment wherein the composition is used as a sizing agent, a material selected from the group consisting of pore volume regulator, defoamers, surfactants, thickeners, and a combination of at least two of the above, may be added to the compositions of the present invention prior to sizing to assist in the sizing process. The resulting material is absorbed by the substrate and may also lie on the surface of the substrate but may not form a continuous film on the surface.

The present invention also encompasses a method for making an ink jet recording sheet by coating the composition comprising a blend of a dye fixative and a metal oxide dispersion on at least one side of said substrate. The composition blend forms a water-insoluble complex which will not wash away when ink is applied, creating recording sheets with enhanced waterfastness and print density properties.

In one embodiment of this method the composition forms a continuous film on the substrate. In another embodiment of this method, the composition containing the water-insoluble complex is absorbed into the surface of the substrate as a sizing material. The composition is absorbed by the substrate and may also lie on the surface of the substrate but does not form a continuous film.

In yet another embodiment of the method of the present invention a material selected from the group consisting of binder, pigment, defoamer, surfactant, thickener, and a combination of at least two of the above. In a further embodiment of the method where the composition is a sizing material, at least one material selected from the group consisting of pore volume regulator, defoamer, surfactant, thickener, and a combination of at least two of the above is added to the composition.

Other objects, features and advantages of the present invention will be apparent when the detailed description of the preferred embodiment of the invention are considered with reference to the drawings which should be construed in an illustrative and not limiting sense as follows:

### BRIEF DESCRIPTION OF THE DRAWINGS

FIG. 1 is a schematic illustration of the ink jet recording sheet according to the first embodiment of the invention wherein the ink jet recording sheet comprises an ink receiving layer.

FIG. 2 is a schematic illustration of the ink jet recording sheet according to the second embodiment of the invention wherein the composition is used as a sizing material.

### DETAILED DESCRIPTION OF THE INVENTION

The present invention is a coating composition comprising a blend of a dye fixative and a dispersion of metal oxide particles that forms a water-insoluble complex. Suitable dye fixatives for the compositions of the recording sheets of the present invention are water-soluble or water-dispersible cationic polymers. The cationic polymer is blended with a dispersion of metal oxide particles, i.e. a water dispersion such as colloidal silica.

Suitable cationic polymers for use in the present invention include dicyandiamide-formaldehyde resin, polyethylenimine-epichlorohydrin, polydiallyldimethylammonium chloride (p-DADMAC or p-DMDAAC polymer), and cationic polymers which contain primary, secondary, tertiary or quaternary amine functionalities. The cationic polymers containing amine functionalities include cationic starches, cationic polyvinyl alcohols, cationic vinyl polymers, cationic styrene-containing polymers, cationic polyurethanes, quarternary amine salts, and the like.

Preferably, the cationic polymer is a quaternary amine salt, most preferably benzyl cocoalkyl dimethyl quaternary ammonium chloride the active ingredient in Arquad DMCB, CAS#61789-71-7 (available in grades 50, 75, and 80 Akzo Nobel Chicago, Ill.). Dicyandiamide-formaldehyde resin, the active ingredient in Fissatore L, CAS #26591-12-8 (Lamberti, SPA, Italy). Dicyandiamide is also known as dicyanodiamide, CAS#461-58-5, which in turn, is also known as dicyandiamin, cyanoguanidine, I-cyanoguanidine, and DICY. Polydiallyldimethylammonium chloride polymer is the active ingredient in Nalco CP-261, CAS#26062-79-3 (Ondeo Nalco Naperville, Ill.). Polyethylenimine-epichlorohydrin is the active ingredient in Lupisol SC86X (BASF, Mount Olive, N.J.).

Suitable metal oxide dispersions include colloidal silica, colloidal alumina, colloidal zirconia, and colloidal titanium dioxide. Colloidal silica is the active ingredient in Ludox HS-40, CAS#7631-86-9 (W. R. Grace, Columbia, Md.). The average diameter of the particles should be in the range of 50 to 500 nm, preferably in the range of 100 to 350 nm, and most preferably in the range of 130 nm to 250 nm.

In the most preferred embodiment, colloidal silica is blended with benzyl cocoalkyl dimethyl quaternary ammonium chloride. The ratio of colloidal silica to benzyl cocoalkyl dimethyl quaternary ammonium is 1:20 to 1:1, and preferably 1:4 by dry weight.

Metal oxides bind to cationic polymers through hydrogen bonding or coordination to electron-rich groups, found on such cationic polymers, such as groups containing oxygen, nitrogen and sulfur. This bond creates a water-insoluble complex that will not wash off when ink is applied. Thus, a mediocre dye fixative can be converted into a dye fixative with superior waterfast properties using a dispersion of metal oxide particles to bind the dye fixative to the substrate.

The present invention is also directed to an ink recording sheet comprising a substrate coated on at least one side with a composition comprising the blend of cationic polymer and dispersion of metal oxide.

In one embodiment, the recording sheet further comprises a continuous film on the substrate. Preferably the continuous film is used as an ink receiving layer.

In a second embodiment, the composition containing the water-insoluble complex is absorbed into the surface of the substrate as a sizing material. The composition is absorbed by the substrate and may also lie on the surface of the substrate, but does not form a continuous film.

In yet another embodiment, the substrate that is sized with the composition of the present invention can then be coated with an ink receiving layer containing the compositions of the present invention.

The substrate is selected from the group consisting of paper, textile and plastic film. Paper substrates include, but are not limited to cellulose based paper, cotton based paper, and RC coated or laminated paper that has a layer of plastic. When the substrate is plastic film, RC coated or laminated paper, it can only be used in the embodiment wherein the recording sheet comprises an ink receiving layer.

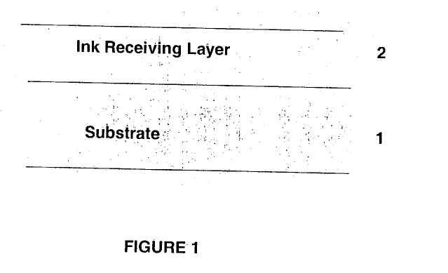

As illustrated in FIG. 1, the compositions containing water-insoluble complexes forms an ink receiving layer 2 on the substrate surface 1. In this embodiment, the layer is a continuous film. This embodiment is used to make what is known in the industry as coated paper, e.g. matte and glossy type paper.

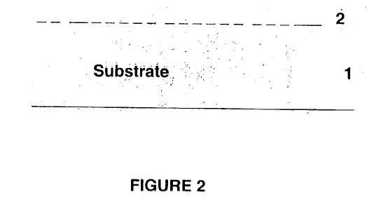

Alternatively, in the second embodiment shown in FIG. 2, the compositions containing water-insoluble complexes are absorbed into the surface 2 of the substrate 1, onto and between the interstices of the fibers of the substrate as a sizing material. In this embodiment, although the paper is being coated with the composition, the conventional terminology of this type of paper to one skilled in the art would be “uncoated.”

More specifically, in the terminology typically used in papermaking, a paper is considered to be uncoated when the paper is produced on a paper machine, and the sizing material is applied with a size press. Another difference between a sizing and a coating is the amount of material which is added to the surface on a dry weight basis. When a paper is sized, the amount of material added to the paper is in the range of 0.1 g/m² to about 2 g/m² on a dry weight basis. This material tends to be absorbed into the paper, and does not generally form a continuous film on the paper surface. The amount that is absorbed vs. the amount that lies on the surface of the substrate depends on the size press machine, as well as the coat weight and viscosity of the coating. For example, a coating with a high viscosity will tend to be less absorbed and remain more on the surface of the paper because it will dry before it can soak into the surface of the paper.

When a paper is coated, as in the case of matte or glossy type paper, the general methods of applying the coating will form a continuous film on the surface of the paper, and the amount of material added to the paper is in the range of 2 g/m² to 30 g/m² on a dry weight basis.

It is within the scope of the invention to coat both sides of the substrate. This is preferred if the paper or coating machine cannot easily be configured for one-sided application of material, or if the intended usage requires two-sided coating.

In the embodiment wherein the composition forms a continuous film on the substrate surface, the resulting ink receiving layer may further comprise a material selected from the group consisting of binder, pigment, defoamer, surfactant, thickeners and a combination of at least two of the above. When the composition containing the blend is combined with these other materials to make an ink receiving layer, the composition generally constitutes 5% to 30% of the ink receiving layer by dry weight, and preferably 5% to 20%, and most preferably 10 to 15%.

The additional materials which may be added to make the ink receiving layer of the recording sheets of the present invention are well known to those skilled in the art, and generally include, but are not limited to polymeric binders alone, or in combination with inorganic pigments. Suitable binders are cold water-insoluble binders such as starch, derivatives of starch (also known as modified starch) such as ethylated starch or cationic starch, cross-linked polyvinyl alcohol, cross-linked derivatives of polyvinyl alcohol or modified polyvinyl alcohol, such as acid modified, cationic modified or graft co-polymers of polyvinyl alcohol, modified cellulosics, such as carboxymethyl cellulose, hydroxyethyl cellulose, and hydroxymethyl cellulose, proteins such as casein, soy and gelatin, vinyl polymers, styrene-containing polymers, and poyurethanes. Preferably, the binder is cross-linked polyvinyl alcohol and styrene-containing polymers. Non cross-linked polyvinyl alcohol may also be used, however, an additional water-insoluble binder such as a latex should be added to the polyvinyl alcohol as a additional binder for the pigment.

If the binder is used in a formulation without pigments, typical of glossy ink jet coatings, then the amount of binder in the ink formulation is between 80% and 100% by dry weight, depending on the amount of other additives such as thickeners and defoamers. If the binder is used in a formulation with pigments, then the amount of binder in the ink receiving layer is between 5% and 50% by dry weight, preferably 10 to 15% for pigments with low porosity or low surface area and 20% to 30% for pigments with high porosity or high surface area.

Suitable pigments include but are not limited to silica, alumina, clay and calcium carbonate, preferably silica. The amount of pigment in the ink receiving layer is in the range of 30% to 90%, by dry weight, and preferably 50% to 75%. Additionally, defoamers, surfactants, thickeners, and a combination of the above may be added to the blends to make the compositions prior to coating. These additives are generally in the range of 0% to 30% of the ink receiving layer by dry weight, and preferably 5% to 20%.

Additionally, defoamers, surfactants, thickeners, dispersants and wetting agents or a combination of the above may be added to the compositions prior to coating. The additives are generally in the range of 0% to 30% of the ink receiving layer by dry weight, and preferably 5% to 20%.

In the embodiment where the compositions are used as a sizing material, pore volume regulators, defoamers, thickeners, surfactants and a combination of at least two of the above may be added to the compositions of the present invention prior to sizing the substrate to assist in the sizing process. In this embodiment, the pore volume regulator includes starch, polyvinyl alcohol, vinyl polymers, or styrene-containing polymers. These materials are therefore not added as binder, but rather as a pore volume regulator, i.e., it is added to regulate the pore volume regulator and thus, how fast the ink absorbs into the recording sheet. Starch, polyvinyl alcohol, vinyl polymers and styrene-containing polymers will slow down the absorption of the ink on the substrate. In turn, slowing down the ink absorption provides and even more improved print quality. Thus, in this embodiment, there is no need for an additional binder for the dye fixative. The amount of pore volume regulator added to the formulation depends on the surface energy of the material. For materials such as starch and polyvinyl alcohol which have high surface energies, the amounts of material in the formulation can vary from 0 to 90% by dry weight, more preferably between 5% and 70% by dry weight, and most preferably between 20% and 50% by dry weight. For materials such as vinyl polymers and styrene-containing polymers, which generally have low surface energies, the amounts of material in the formulation can vary from 0 to 20% by dry weight, more preferably between 0 and 10% by dry weight, and most preferably between 0 and 5% by dry weight. Other ingredients such as defoamers, thickeners, and the like can vary from 0 to 30% by dry weight, more preferably between 5 and 20% by dry weight, and most preferably between 5 and 10% by dry weight.

Some coating materials are sensitive to acidic pH levels. If this is of concern then the pH of the compositions should be checked and, if necessary, adjusted to between 6 and 8, before the additional materials are added. This is especially important when starch is used as a binder (or a sizing material). Starch degrades in the presence of acid and since most dye fixatives are commercially available at acidic pH's the starch will degrade before it is effectively combined with the blend composition to form the ink receiving layer.

It is also important to note that, when the composition is used as a sizing material, the percentage of solids in the coating applied to the paper is generally low e.g. 3% to 10%, because the composition is diluted with water. In this instance the water-insoluble complex will be in the form of a colloidal suspension and will precipitate out after it is applied to the substrate and the water evaporates. When the composition is used as part of an ink receiving layer, the percentage of solids in the coating that becomes the ink receiving layer is more concentrated e.g. 30% to 50%, and the complex will precipitate before it is applied, requiring the composition and any additional materials added to the composition to make the ink receiving layer to be vigorously stirred.

The present invention also encompasses a method for making an ink jet recording sheet by coating a composition comprising a blend of the dye fixative and a metal oxide dispersion on at least one side of a substrate; and allowing the coating to dry. The blend forms a water-insoluble complex which will not wash away when ink is applied creating recording sheets with enhanced waterfastness and print density properties.

The composition is absorbed is absorbed into the surface of the substrate as a sizing material, or alternatively, forms a continuous film on the substrate surface. In both of these embodiments, the coating should be allowed to dry before printing images.

In the embodiment wherein the composition forms a continuous film on the substrate surface, the continuous film is an ink receiving layer which further comprises a material selected from the group consisting of binder, pigment, defoamer, surfactant, thickener, and a combination of at least two of the above is added to composition. In a further embodiment of the method where the composition is a sizing material, at least one material selected from the group consisting of pore volume regulator, defoamer, surfactant, thickener, and a combination of at least two of the above is added to the composition.

The present invention will be illustrated in more detail by the following examples without limiting the scope of the claimed compositions or method in any way.

### EXAMPLES

### Example I

The print density and waterfastness of an ink jet recording sheet according to the present invention was tested. The specific formulation tested is set forth below in Table I. This example is of a size press formulation containing a dye fixative, colloidal silica, and starch.

TABLE I
Formulation of Dye Fixative Composition Used in Size Press

| | Quantity | Concentration | Dry Weight |
|---|---|---|---|
| Ingredient | (g) | (% solids) | Ratio (%) |
| Starch | 31.496 | 10 | 31.25 |
| Arquad | 7.087 | 80 | 56.25 |
| DMCB-80 | | | |
| Ludox HS-40 | 3.150 | 40 | 12.50 |
| Water | 58.268 | 0 | 0.00 |
| Totals | 100 | 10 | 100 |

Arquad DMCB-80 is benzyl cocoalkyl dimethyl quaternary ammonium chloride, CAS# 61789-71-7 (Akzo Nobel Chicago, IL).
Ludox HS-40 is colloidal silica, CAS# 7631-86-9 (W. R. Grace, Columbia, MD).

The starch used in this example was a Penford hydroxyethyl starch, designated PG-290, CAS#9005-27-0 (Penford Products, Cedar Rapids, Iowa). This starch was cooked in a starch cooker following the heating schedule recommended by the manufacturer at a concentration of 10% solids. The dye fixative, Arquad DMCB-80, and colloidal silica, Ludox HS-40, were received from the manufacturers as solutions in water, with concentrations shown in Table I. The colloidal silica was added to tap water in the quantities shown in Table I, followed by the addition of the dye fixative, Arquad DMCB-80. The percent solids of the solution was 10% in total solids, and the viscosity was less than 20 cps. The solids content of the solution was measured in a commercially available microwave solids oven, manufactured by CEM, model LabWave 9000. The solution viscosity was measured with a Brookfield viscometer, model DV-II, using a #2 spindle at 100 rpm. The dye fixative-containing solution was then poured into the starch solution in the quantities shown in Table 1 to make 100 g of the sizing formulation.

The sizing formulation was applied to a paper with no existing surface sizing. This paper was taped to a supporting paper, and the solution applied to the paper using a #10 wire wound rod to meter off the solution. The paper was then dried in a forced air oven at 120°C. for two minutes. The paper was weighed before and after sizing, and the amount of sizing added was about 1 g/m². The amounts of each ingredient in the dried sizing can be calculated from the values listed in Table I in the column entitled Dry Weight Ratio.

The paper was then loaded into a Hewlett Packard DeskJet 722C ink jet printer, and solid blocks of several colors were printed onto the paper, using the plain paper setting of the printer. These colors included cyan, magenta, yellow, and black. The print density of each colored block was measured using an X-Rite model 404 spectrophotometer. The waterfastness was determined by comparing the print density before and after soaking the printed paper in tap water for 1 minute. The change in print density for each colored block was calculated by the following equation:

$$\% Change = \frac{( Density After - Density Before ) \times 100}{Density Before}$$

For this calculation, if the density after soaking is less than the density before soaking, then the % change will be a negative value. Therefore, poor dye fixatives will have large negative % change for one or more of the colored blocks measured. The print density and waterfastness test results are in Table III.

### Example II

TABLE II
Formulation of Dye Fixative Composition Used in Size Press

| | Quantity | Concentration | Dry Weight |
|---|---|---|---|
| Ingredient | (g) | (% solids) | Ratio (%) |
| Starch | 33.6 | 10 | 33.3 |
| Arquad DMCB-80 | 7.6 | 80 | 60.0 |
| Ludox HS-40 | 1.7 | 40 | 6.7 |
| Water | 57.1 | 0 | 0 |
| Totals | 100 | 10 | 100 |

Arquad DMCB-80 is benzyl cocoalkyl dimethyl quaternary ammonium chloride, CAS# 61789-71-7 (Akzo Nobel Chicago, IL).
Ludox HS-40 is colloidal silica, CAS# 7631-86-9 (W. R. Grace, Columbia, MD).

The dye fixative, Arquad DMCB-80 and the colloidal silica, Ludox HS-40, were received from the manufacturers as solutions in water, with concentrations shown in Table I. The Ludox was added to tap water in the quantities shown in Table I, followed by the Arquad. The percent solids of the solution was 10% in total solids, and the viscosity was less than 20 cps. This mixture was then added to a cooked starch solution, also at 10% solids, in the quantities shown in Table 1 to make 100 g of the sizing formulation.

Sizing of paper with no existing surface sizing was performed in the lab using the same conditions as described above in Example I. The paper was then printed and tested using the same conditions as described above in Example I. The print density and waterfastness test results are in Table III.

TABLE III
Print Density and Waterfastness Test Results

| | | Print Density | | | |
|---|---|---|---|---|---|
| Sample ID | | C | M | Y | K |
| Example I | Before soaking | 1.09 | 1.31 | 1.10 | 1.32 |
| | After soaking | 1.07 | 1.31 | 1.00 | 1.38 |
| | % Change | −1.8 | 0.0 | −9.1 | 4.5 |
| Example II | Before soaking | 1.11 | 1.32 | 1.12 | 1.34 |
| | After soaking | 1.02 | 1.30 | 0.98 | 1.32 |
| | % Change | −8.1 | −1.5 | −12.5 | −1.5 |

C = cyan,
M = Magenta,
Y = yellow,
K =black

### Example III

TABLE IV
Formulation of Dye Fixative Blend Used
in Matte Ink Receiving Layer

| | Quantity | Concentration | Dry Weight |
|---|---|---|---|
| Ingredient | (g) | (%) | Ratio (%) |
| Sylojet 405 | 10.6 | 100 | 55.9 |
| Disperbyk 190 | 1.1 | 40 | 2.2 |
| Arquad DMCB | 2.4 | 44 | 10.1 |
| Ludox HS-40 | 1.1 | 50 | 2.2 |
| Water | 51.2 | 0 | 0 |
| Sodium Hydroxide | 0.2 | 50 | 0 |
| Celvol 523 | 19.1 | 10 | 10.0 |
| CDP 3117-9 | 14.3 | 26 | 19.6 |
| Totals | 100 | 17.8 | 100 |

Sylojet 405 is a silica gel, CAS# 63231-67-4 (W. R. Grace, Columbia, MD)
Disperbyk 190 is a dispersant, (Byk-Chemie, Wallingford, CT)
Arquad DMCB is benzyl cocoalkyl dimethyl quaternary ammonium chloride, CAS# 61789-71-7 (Akzo Nobel Chicago, IL).
Ludox HS-40 is colloidal silica, CAS# 7631-86-9 (W. R. Grace, Columbia, MD).
Celvol 523 is a poly(vinyl alcohol), CAS# 25213-24-5 (Celanese Chemicals, Dallas, TX)
CDP 3117-9 is a styrene-containing polymer, (OMNOVA, Fairlawn, OH)

The ingredients in Table IV were mixed using the following procedure. Water was added to a vessel of suitable size, followed by the Disperbyk 190, Arquad DMCB, and Ludox HS-40 with stirring. The silica was then added, and the mixture stirred under high sheer for about 20 minutes. The Celvol and CDP polymer were then added, and the mixture stirred at low speed for 10 minutes. Sodium hydroxide was then added to the final mixture to bring the pH in the 6-8 range.

The coating mixture was applied to a paper with no existing surface sizing. This paper was taped to a supporting paper, and the solution applied to the paper using a #26 wire wound rod to meter off the solution. The paper was then dried in a forced air oven at 120 degrees C. for two minutes. The paper was weighed before and after coating, and the amount of coating added was about 10 g/m². The amounts of each ingredient in the dried coating can be calculated from the values listed in Table IV in the column entitled Dry Weight Ratio.

Finally, variations from the examples given here are possible in view of the above-disclosure. Therefore, although the invention has been described with reference to certain preferred embodiments, it will be appreciated that other compositions may be devised, which are nevertheless within the scope and spirit of the invention as defined in the claims appended hereto.

The invention now being fully described, it will be apparent to one of ordinary skill in the art that many changes and modifications can be made thereto without departing from the spirit or scope of the invention as set forth herein.

1. A coating composition comprising a blend of a cationic polymer and a dispersion of metal oxide particles wherein said blend forms a water-insoluble complex.

2. The composition according to claim 1 wherein the cationic polymer is selected from the group consisting of dicyandiamide-formaldehyde resin, polyethylenimine-epichlorohydrin, polydiallyidimethylammonium chloride, and cationic polymers which contain primary, secondary, tertiary or quaternary amine functionalities.

3. The composition according to claim 2 wherein the cationic polymers containing quaternary amine functionalities is a quaternary ammonium salt.

4. The composition according to claim 3 wherein the quaternary ammonium salt is benzyl cocoalkyl dimethyl quaternary ammonium chloride.

5. The composition according to claim 1 wherein the dispersion of metal oxide particles is selected from the group consisting of colloidal silica, colloidal alumina, colloidal zirconia, and colloidal titanium dioxide.

6. The composition according to claim 1 wherein the cationic polymer is benzyl cocoalkyl dimethyl quaternary ammonium chloride and the dispersion of metal oxide is colloidal silica.

7. The composition according to claim 6 wherein the ratio of benzyl cocoalkyl dimethyl quaternary ammonium chloride to colloidal silica is 1:20 to 1:1.

8. The composition according to claim 7 wherein the ratio of benzyl cocoalkyl dimethyl quaternary ammonium chloride to the colloidal silica is 1:4.

9. An ink jet recording sheet comprising a substrate coated on at least one surface with a composition comprising a blend of a dye fixative and a dispersion of metal oxide polymers, wherein said dye fixative is a cationic polymer and said blend forms a water-insoluble complex.

10. The ink recording sheet according to claim 9 wherein the substrate is selected from the group consisting of paper, textile and plastic film.

11. The recording sheet according to claim 9 wherein said composition forms a continuous film on said substrate surface.

12. The recording sheet according to claim 9 wherein said composition is absorbed into the surface of said substrate as a sizing material.

13. The recording sheet according to claim 11 wherein said continuous film is an ink receiving layer which further comprises a material selected from the group consisting of binders, pigments, defoamers, surfactants, thickeners and a combination of at least two of the materials.

14. The recording sheet according to claim 12 wherein said composition further comprises a material selected from the group consisting of pore volume regulators, defoamers, surfactants, thickeners and a combination of at least two of the materials.

15. The recording sheet according to claim 13 wherein said binders are selected from the group consisting of starch, derivatives of starch, modified starch, cross-linked polyvinyl alcohol, cross-linked derivatives of polyvinyl alcohol, modified polyvinyl alcohol, modified cellulosics, proteins, vinyl polymers, styrene-containing polymers, and polyurethanes.

16. The recording sheet according to claim 13 wherein said pigment is selected from the group consisting of silica, alumina, clay, and calcium carbonate.

17. A method for making an ink jet recording sheet comprising:
providing a composition comprising a blend of a dye fixative and a metal oxide dispersion, wherein said blend forms a water-insoluble complex;
providing a substrate; and
coating said composition on at least one surface of said substrate.

18. The method according to claim 17 wherein the composition forms a continuous film on said substrate.

19. The method according to claim 17 wherein the composition is absorbed into the surface of said substrate as a sizing material.

20. The method of claim 18 wherein said composition further comprises at least one material selected from the group consisting of binder, pigments, defoamers, surfactants, thickeners, and a combination of at least two of the materials.

21. The method according to claim 19 wherein said composition further comprises at least one material selected from the group consisting of pore volume regulators, defoamers, surfactants, thickeners and a combination of at least two of the materials.
